(19) United States
(12) Patent Application Publication
(10) Pub. No.: US 2012/0308292 A1
(43) Pub. Date: Dec. 6, 2012

(54) PENHOLDER

(76) Inventor: Yuan-Ning LEE, Taipei City (TW)

(21) Appl. No.: 13/153,800

(22) Filed: Jun. 6, 2011

(51) Int. Cl. B43K 23/00

(52) U.S. Cl. 401/292

(57) ABSTRACT

A penholder provides a consumer to change by oneself a pattern, color or even model of pan body. The said penholder includes an inner sleeve, at least one outer sleeve and a dismountable fixing cap. The dismountable fixing cap is provided on a top end of the inner sleeve and forms a limiting function to the outer sleeve to prevent it from dropping. Selectively, at least one protruded member is provided on the inner sleeve or the dismountable fixing cap at a place where the inner sleeve or the dismountable fixing cap is abutted at the outer sleeve. Moreover, a recess is provided on an end rim of the outer sleeve to be latched in by the protruded member. Therefore, a penholder is provided, wherein by simply replacing the outer sleeve, a pattern, color or even model of the pen body can be changed.

### BACKGROUND OF THE INVENTION

a) Field of the Invention

The present invention relates to a penholder, and more particularly to a penholder which can provide a user to change by oneself a different pattern, color or even model of the pen body.

b) Description of the Prior Art

A pen is one of the most convenient and used most often writing tools in a daily life. Therefore, students, office workers, engineers, business staffs or even ordinary house wives will use the pens frequently. In addition to being provided with a refill for writing, an ordinary pen should also be provided with a penholder to facilitate holding. Accordingly, there are a lot of pens on the market with various pleasing visual effects by utilizing the model, color and pattern design of the penholder, so as to promote the market competitiveness.

On the other hand, an ordinary consumer will mostly purchase pens of different writing features and different pen colors for use in different conditions for various needs. Hence, the market will provide the pens of different functions and pen colors for the consumers to choose, including all kinds of product lines of various refills, such that the consumers can replace the refills by themselves.

However, the pens are primarily featured in an appearance by the patterns, colors or even models constituted by the penholders. Thus, some consumers will purchase several pens with a same function and pen color but with different patterns and colors of the penholders, in order to fit with different clothing. Accordingly, not only that cost in purchasing the pens will increase, but also that it will cause a lot of inconvenience in collecting and carrying the pens.

### SUMMARY OF THE INVENTION

Accordingly, the primary object of the present invention is to provide a penholder which can provide a user to change by oneself a different pattern, color or even model of the pen body.

To achieve the aforementioned object, the penholder of the present invention includes primarily an inner sleeve, at least one outer sleeve and a dismountable fixing cap. The inner sleeve is used primarily to emplace a refill, and a step is formed on an outer wall at a place close to a bottom end of the inner sleeve. At least one outer sleeve is sheathed on an outer layer of the inner sleeve, and a bottom end of the outer sleeve is abutted at the step of the inner sleeve. On the other hand, the dismountable fixing cap is provided on a top end of the inner sleeve and constitutes a limiting function to the outer sleeve to prevent it from dropping.

In addition, selectively, at least one protruded portion is provided on the outer wall of the inner sleeve or at least one protruded member is provided on the dismountable fixing cap at a place where the dismountable fixing cap is abutted at the outer sleeve. Besides, at least one recess is provided on an end rim of at least one outer sleeve, allowing the protruded member of the inner sleeve or the dismountable fixing cap to be latched in, thereby preventing the outer sleeve from rotating freely.

Accordingly, the entire penholder can utilize the at least one outer sleeve to serve as a main body for modeling and refinishing, allowing the consumer to simply assemble and disassemble the dismountable fixing cap that the outer sleeve of a different model and pattern can be sheathed selectively on the outer layer of the inner sleeve for use, so as to achieve a penholder providing the user to change by oneself a different pattern, color or even model of the pen body.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of an appearance of a first usage state of the present invention.

FIG. 2 shows a schematic view of an appearance of a second usage state of the present invention.

FIG. 3 shows an exploded view of structures of the present invention.

FIG. 4 shows a structural view of an appearance of a second embodiment of the present invention.

### DETAILED DESCRIPTION OF THE PREFERRED EMBODIMENTS

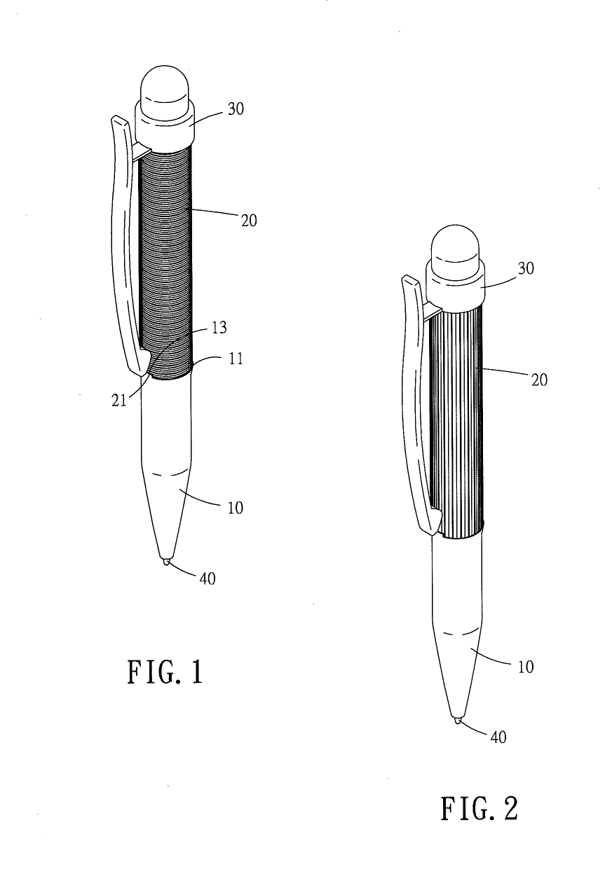

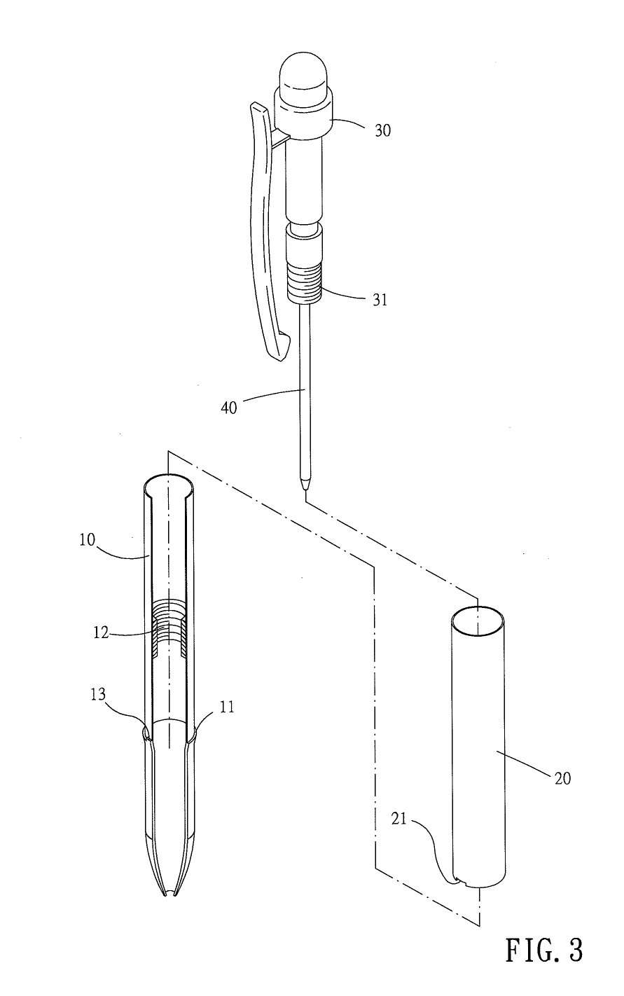

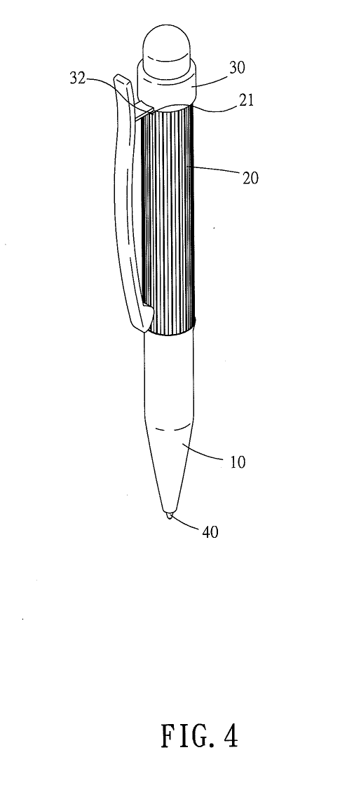

Referring to FIG. 1 and FIG. 2, a penholder of the present invention comprises an inner sleeve 10, at least one outer sleeve 20 and a dismountable fixing cap 30, where by simply replacing the outer sleeve 20, a pattern, color or even model of the pen body can be changed. Referring to FIG. 3 and FIG. 4 at a same time, the inner sleeve 10 is used primarily to emplace a refill 40 and a step 11 is formed on an outer wall at a place close to a bottom end of the inner sleeve 10. Each outer sleeve 20 is sheathed on an outer layer of the inner sleeve 10, and a bottom end is abutted at the step 11 of the inner sleeve 10.

On the other hand, the dismountable fixing cap 30 is provided on a top end of the inner sleeve 10 and constitutes a limiting function to the outer sleeve 20 to prevent it from dropping. Upon implementing, the dismountable fixing cap 30 is provided with an outer threaded section 31 which is extended into the inner sleeve 10 and the outer threaded section 31 is screwed with an inner threaded section 12 of the inner sleeve 10, thereby assembling the dismountable fixing cap 30 with the inner sleeve 10.

In the embodiment shown in FIGS. 1 to 3, the inner sleeve 10 is provided with the inner threaded section 12 on an inner wall and at least one protruded member 13 on an outer wall; whereas, each outer sleeve 20 is provided associatively on an end rim with at least one recess 21 to, be latched in by the protruded member 13 of the inner sleeve 10, thereby restricting the outer sleeve 20 from rotating freely.

Of course, as shown in FIG. 4, the penholder of the present invention can be that at least one protruded member 32 is provided on the dismountable fixing cap 30 at a place where the dismountable fixing cap 30 is abutted at the outer sleeve 20. Similarly, each outer sleeve 20 is provided associatively on an end rim with at least one recess 21, allowing the protruded member 32 of the dismountable fixing cap 30 to be latched in, so as to restrict the outer sleeve 20 from rotating freely. It is certain that the protruded member 32 of the dismountable fixing cap 30 can be provided below the cap to hide shapes of the protruded member 32 and the recess 21, thereby increasing a pleasing visual effect of the entire penholder.

Accordingly, the entire penholder of the present invention can utilize at least one outer sleeve 20 to serve as a main body for modeling and refinishing, and the consumer can easily assemble and disassemble the dismountable fixing cap 30 that the outer sleeve 20 of a different model or pattern can be sheathed selectively on the outer layer of the inner sleeve 10 for use, thereby achieving an effect of easily changing the pattern, color or even model of the pen body.

In particular, upon specifically implementing, the dismountable fixing cap 30 can be inserted with at least one refill 40 in advance, and a pen with the refill 40 will be constituted when the dismountable fixing cap 30 is assembled with the inner sleeve 10.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A penholder comprising:
an inner sleeve which is used to emplace a refill, with a step being formed on an outer wall at a place close to a bottom end of the inner sleeve;
at least one outer sleeve, which is sheathed on an outer layer of the inner sleeve and a bottom end of which is abutted at the step of the inner sleeve; and
a dismountable fixing cap, which is provided on a top end of the inner sleeve and constitutes a limiting function to the outer sleeve thereby preventing it from dropping; with that at least one protruded member is provided on the outer wall of the inner sleeve and each outer sleeve is provided with at least one recess at an end rim, thereby allowing the protruded member of the inner sleeve to be latched in.

2. A penholder comprising:
an inner sleeve which is used to emplace a refill, with a step being formed on an outer wall at a place close to a bottom end of the inner sleeve;
at least one outer sleeve, which is sheathed on an outer layer of the inner sleeve and a bottom end of which is abutted at the step of the inner sleeve; and
a dismountable fixing cap, which is provided on a top end of the inner sleeve and constitutes a limiting function to the outer sleeve thereby preventing it from dropping; with that at least one protruded member is provided on the dismountable fixing cap at a place where the dismountable fixing cap is abutted at the outer sleeve and each outer sleeve is provided with at least one recess at an end rim, thereby allowing the protruded member of the dismountable fixing cap to be latched in.

3. The penholder according to claim 2, wherein the protruded member of the dismountable fixing cap is located below the cap.

4. The penholder according to claim 1, wherein an inner wall of the inner sleeve is provided with an inner threaded section, the dismountable fixing cap is provided correspondingly with an outer threaded section which is extended into the inner sleeve, and the outer threaded section is screwed with the inner threaded section of the inner sleeve.

5. The penholder according to claim 2, wherein an inner wall of the inner sleeve is provided with an inner threaded section, the dismountable fixing cap is provided correspondingly with an outer threaded section which is extended into the inner sleeve, and the outer threaded section is screwed with the inner threaded section of the inner sleeve.

6. The penholder according to claim 1, wherein the dismountable fixing cap is inserted with at least one refill in advance.

7. The penholder according to claim 2, wherein the dismountable fixing cap is inserted with at least one refill in advance.
